(19) United States
(12) Patent Application Publication
(10) Pub. No.: US 2015/0200832 A1
(43) Pub. Date: Jul. 16, 2015

(54) Adaptive Document Autosaving Rate Based on Different Conditions

(71) Applicants: Andrian Kurniady, Sydney (AU); Vadim Gerasimov, Epping (AU); Dmitri Abramov, Liberty Grove (AU); Anil Sabharwal, Pymble (AU); David John Olsen, Croydon (AU)

(72) Inventors: Andrian Kurniady, Sydney (AU); Vadim Gerasimov, Epping (AU); Dmitri Abramov, Liberty Grove (AU); Anil Sabharwal, Pymble (AU); David John Olsen, Croydon (AU)

(21) Appl. No.: 13/482,546

(22) Filed: May 29, 2012

Related U.S. Application Data
(60) Provisional application No. 61/600,383, filed on Feb. 17, 2012.

(51) Int. Cl. H04L 12/26; G06F 15/16

(52) U.S. Cl. CPC H04L 43/0894

(57) ABSTRACT

A method for collaborative document editing determines a document update upload rate based on edit characteristics. The document update upload rate is used to determine when edits made via a particular user device are sent to a document collaboration server. The edit characteristics include a number of a plurality of users collaboratively editing a document, a current edit location within the document for one of the users, and the type of connection and speed of the connection between a user device and the document collaboration server. The document update upload rate can be determined in response to a change in one of the edit characteristics.

This application claims the benefit of U.S. Provisional Application No. 61/600,383 filed Feb. 17, 2012, which is incorporated herein by reference.

### BACKGROUND

The present disclosure relates generally to collaborative document editing, and more particularly to determining a document update upload rate based on edit characteristics.

Simultaneous document collaboration allows multiple users to edit a document at the same time. Two or more user devices communicate over a network, such as a local area network or the Internet, with a server that maintains a master copy of a document. In order to ensure that changes made to local copies of documents edited at the user devices are displayed to all users, the master copy of the document is updated as edits are made or as soon as possible thereafter. A copy of the updated master document, or an indication of the changes made to it, is then transmitted to each user device currently editing the master document. Although this works well in an unlimited-access high-bandwidth environment, immediate update of collaboration documents may not be desirable when using limited access and lower bandwidth connections via, for example, a mobile device.

### BRIEF SUMMARY

In one embodiment, a method for collaborative document editing includes receiving a request at a document collaboration server from a user device for a master document. The document collaboration server determines a first document update upload rate for the user device based on a connection type and speed between the user device and the document collaboration server. The document collaboration server transmits a copy of a master document and a document update upload rate to the first user device. Edits from the user editing the copy of the master document are received at the document collaboration server and the server determines a second document update upload rate based on edit characteristics including the number of users editing copies of the master document and a current edit location within a copy of the master document for the user. The second document update upload rate is then transmitted to the user device.

In one embodiment, edits from a second user editing a second copy of the master document are received by the document collaboration server. The document collaboration server then determines a document update upload rate for the second user and a new document update upload rate for the first user. In one embodiment, the document collaboration server determines a plurality of prospective document update upload rates each of which is associated with a corresponding edit characteristic. The document update upload rates for the users are then transmitted to the users.

A method for collaborative document editing from a user device and articles of manufacture including a tangible computer-readable medium are also disclosed.

These and other advantages of the disclosure will be apparent to those of ordinary skill in the art by reference to the following detailed description and the accompanying drawings.

### BRIEF DESCRIPTION OF THE DRAWINGS

FIG. 1 depicts a high level schematic of a system for supporting collaborative document editing;

FIG. 2A depicts a flowchart of a method for collaborative document editing;

FIG. 2B depicts a flowchart detailing one of the steps depicted in the flowchart of FIG. 2A;

FIG. 3 depicts an example of a user table;

FIG. 4 depicts an example of a document table; and

FIG. 5 depicts a high-level block diagram of an exemplary computer that may be used to implement various systems, apparatus and methods described herein.

### DETAILED DESCRIPTION

In one embodiment, a document collaboration server controls access by multiple users to documents stored in a database. The document collaboration server also receives edits made to documents by users and determines the rate at which edits should be transmitted from user devices to the collaborative document server based on edit characteristics.

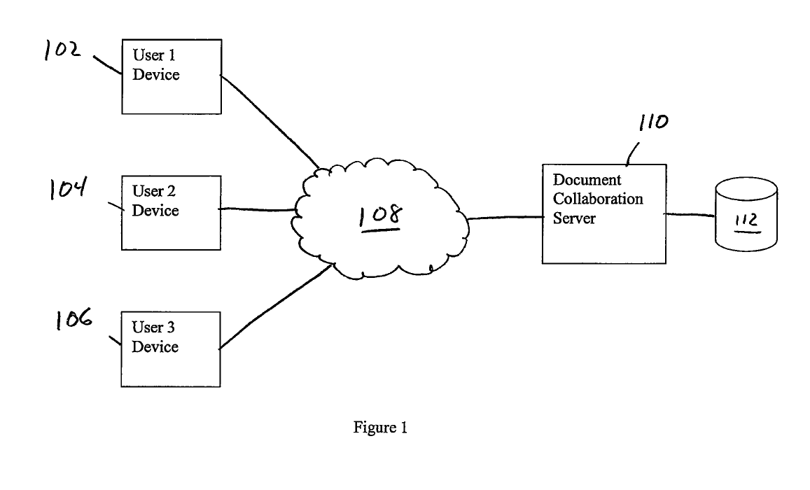

Document collaboration allows multiple users to simultaneously edit a document. Users collaboratively editing a document may be in contact with one another via another mode of communication, such as voice using a computer or mobile device. Document collaboration allows multiple users to edit a document while allowing all users to see changes made by each user. This collaboration allows users to discuss and make proposed changes thereby facilitating changes, and approval of changes, quickly and efficiently. FIG. 1 depicts a high level schematic of a system for collaborative document editing. Multiple user devices (i.e., user 1 device 102, user 2 device 104, and user 3 device 106) each associated with a particular user are in communication via network 108 with document collaboration server 110. Document collaboration server 110 is also in communication with database 112 which stores documents and related version information. Users can simultaneously edit a document provided by document collaboration server 110.

User devices 102, 104, 106 can be any type of communication device capable of operating software to support document editing and communicating with document collaboration server 110. For example, a desktop computer, a laptop computer, or a handheld communication device such as a smart phone or personal digital assistant. User devices 102, 104, 106 are shown in communication with document collaboration server 110 via network 108 which can be any type of network such as a wide or world area network, local area network, wireline network, wireless network, etc.

Document collaboration server 110 controls access via user devices 102, 104, and 106 to documents (e.g. master documents) stored in database 112. In one embodiment, document collaboration server 110 receives requests from users for access to documents and determines a document update upload rate for each user accessing a document. The document update upload rate is the rate or frequency at which edits made by users are transmitted from user devices (e.g., 102, 104, 106) to document collaboration server 110 and is based on one or more edit characteristics discussed in detail below. The document update upload rate for each user device can be different and customized.

Document collaboration server 110 stores and retrieves documents in database 112. Original documents, subsequent versions of documents, and information related to users editing documents are stored in database 112. Copies of a particular document may be transmitted to multiple users wherein the particular original document is referred to as a master document.

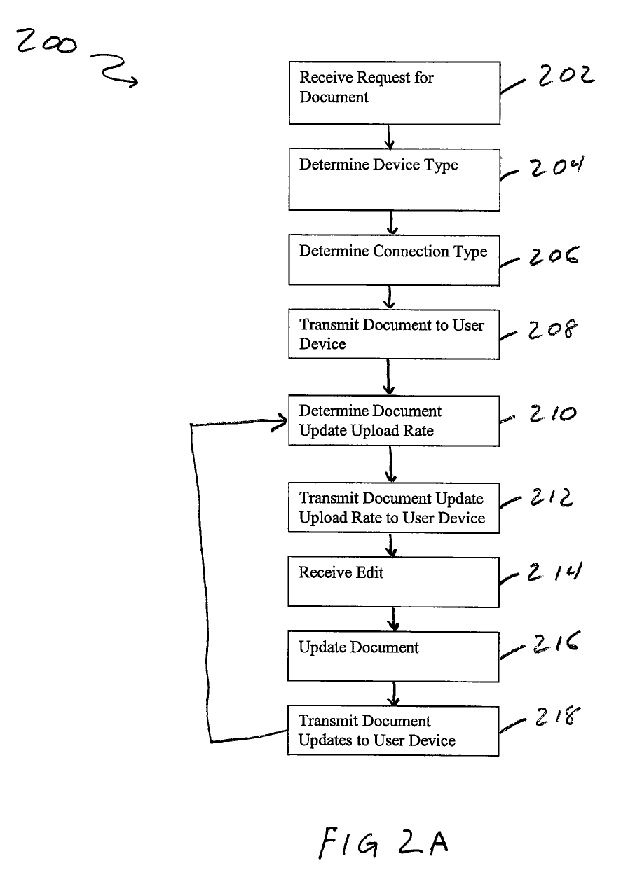

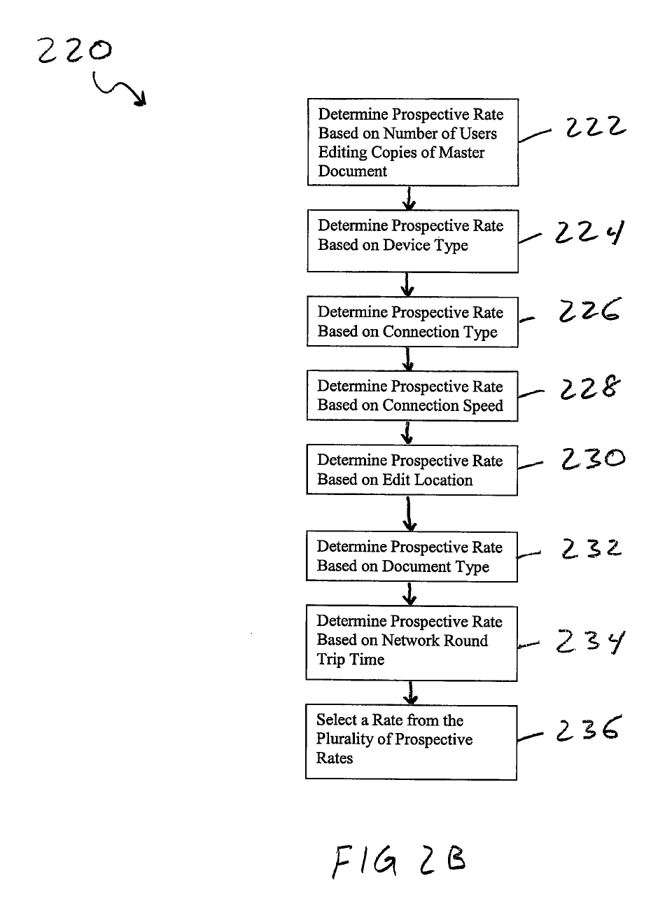

FIG. 2A depicts a flowchart of a method for collaborative document editing according to one embodiment. A user (e.g., user 1) who wants to access a document transmits a request for the document to document collaboration server 110. At step 202, document collaboration server 110 receives the request for a document. At step 204, document collaboration server 110 determines the device type of the device sending the request (in this case user 1 device 102). For the present example, user device 102 is a wireless mobile communication device. At step 206, document collaboration server 110 determines the connection type between the user device sending the request and document collaboration server 110. At step 208, a copy of the requested document (also referred to as a copy of the master document) is transmitted by the document collaboration server 110 to the user device sending the request.

At step 210, document collaboration server 110 determines the document update upload rate for use by user device 102 while the transmitted document is being edited. At step 212, document collaboration server 110 transmits the document update upload rate to a user device (e.g. user 1 device 102). At step 214, document collaboration server 110 receives an edit from the user device (e.g. user 1 device 102). The edit is used to update a master copy of the document currently stored in document collaboration server 110. At step 218, document collaboration server 110 transmits document updates to all users currently collaboratively editing the document.

It should be noted that the method depicted by flowchart 200 can be implemented for multiple users who want to edit the same document. For each user device accessing the same document, steps 202-208 are performed during an initial request. Steps 210-218 are performed periodically for each user device currently accessing the same document. When multiple users are editing the same document, at step 218, document updates are transmitted to each user device that is currently being used to edit the same document. It should also be noted that the document update upload rate, in one embodiment, can be determined by a user device (e.g., user 1 device 102) which can determine its connection type, speed, and also the position of its cursor (i.e. the current edit location). Further, the document update upload rate can be determined in part by document collaboration server 110 and in part by a user device (e.g., user 1 device 102).

The document update upload rate determined in step 210 is based on one or more factors referred to as edit characteristics. In one embodiment, the edit characteristics include the number of users editing a document, type of user device, connection type and speed between a user device (e.g., user 1 device 102) and document collaboration server 110, current edit location within a document for a user, type of document.

FIG. 2B depicts flowchart 220 detailing steps performed in step 210 of FIG. 2A in which a document update upload rate is determined. At step 222, a prospective document update upload rate is determined based on a particular edit characteristic, in this case, the number of users editing copies of a master document. In one embodiment, a prospective document update upload rate is determined by identifying a particular rate associated with a corresponding value for a particular edit characteristic. For example, a table containing a list of values for a particular edit characteristic (e.g., number of users editing a document) and corresponding list of document update upload rates (e.g, a time value in units, such as, milliseconds, seconds, or minutes) can be accessed to determine a prospective document update upload rate for a particular value of a particular edit characteristic. Additional prospective document update upload rates can be determined in a similar manner for steps 224-234. At step 224, a prospective document update upload rate based on device type is determined. At steps 226 and 228, prospective document update upload rates based on connection type and speed, respectively, are determined. At step 230, a prospective document update upload rate based on the location in a document a user is making edits is determined. At step 232, a prospective document update upload rate based on the type of a document being edited is determined. At step 234, a prospective document update upload rate based on a network round trip time between a user device (e.g., user 1 device 102) and document collaboration server 110 is determined.

At step 236, one of the plurality of prospective document update upload rates is selected for use as the document update upload rate. In one embodiment, the fastest prospective document update upload rate (lowest, or shortest, time value which provides the most frequent transmission of updates) determined in steps 222-232 is selected for use as the document update upload rate. In one embodiment, if the fastest prospective document update upload rate from one of steps 222-232 is faster than the prospective document update upload rate determined in step 234, then the rate determined in step 234 is used instead. This is because, in one embodiment, the prospective rate determined based on the network round trip time is used as a minimum value for the document update upload rate for reasons described in detail below.

The document update upload rate affects how soon other users accessing a document can see changes made by a particular user. For example, if a user makes a change in a document via user 1 device 102, the change must be transmitted from user 1 device 102 to document collaboration server 110 and then to user 2 device 104 and user 3 device 106 in order for the users associated with user 2 device 104 and user 3 device 106 to be aware of changes made by the user associated with user 1 device 102. Multiple users editing a document can be provided with almost instantaneous updates by setting a document update upload rate to transmit updates from a device every few milliseconds or after every keystroke. However, device, bandwidth, and cost constraints, among other considerations, can make transmission of frequent updates impractical or undesirable. For example, instantaneous updates using devices that have limited bandwidth may not be possible. In addition, mobile communication devices may be limited to the amount of data that can be transmitted according to a plan associated with a specific cost. Data transmission in excess of plan limits may incur undesirable additional charges.

One of the edit characteristics used in determining the document update upload rate is the number of users simultaneously editing a particular document. Generally, the greater the number of users simultaneously editing a particular document, the more frequently updates should be uploaded to document collaboration server 110, for example, every 200 milliseconds to 30 seconds. If only one user is currently editing the particular document, the document update upload rate can be less frequent than when multiple users are editing the particular document, for example, every 10 seconds to 2 minutes. In the case of a single user editing the document, the document update upload rate can be based on how often edits need to be transmitted to document collaboration server 110 and saved in order to prevent loss of edits due to, for example, unexpected termination of a connection between a user device (e.g., user device 102) and document collaboration server 110.

Another edit characteristic used in determining the document update upload rate is the type of user device with which a user edits a document. Depending on the type of user device, only a portion of a document may be saved locally and, therefore, more frequent updates should be transmitted in order to prevent loss of edits. The type of device may also limit the rate at which edits can be communicated because of bandwidth constraints. For example, a mobile communication device may be associated with a data plan. If the data plan limits the amount of data that may be transmitted to and from the device, frequent transmission of updates may be undesirable. In addition, use of a mobile device while roaming may result in incurring additional charges. The document update upload rate can be adjusted to be less frequent for mobile devices associated with limited data plans or when a mobile device is incurring additional charges for roaming. Further, the document update upload rate can be adjusted to be less frequent when a user reaches or exceeds a threshold related to data usage.

Another edit characteristic used in determining the document update upload rate is the connection type and speed. For example, a wireless connection for a mobile device may be limited with respect to the amount of data the device can transmit. For example, for slower connection speeds, the document update upload rate can be adjusted to transmit updates less frequently in order to cache a group of edits prior to transmitting the edits. For faster connection speeds, the document update upload rate can be adjusted to transmit updates more frequently than for slow connection speeds. In one embodiment, a minimum value of 200 milliseconds is used for high speed connections such as Wi-Fi and a minimum of 3 seconds for 3G networks.

Another edit characteristic is the current edit location within a document for a user. If two users are editing the same document but on different pages, edits made by one user on one page should not affect edits made by another user on another page. Accordingly, there is little urgency to update one user's document to reflect changes made by the other user. As the relative location where users are making edits within the document become closer, there is a greater probability that edits made by one user will affect edits made by another user. For example, if two users are attempting to update the same sentence, it would be beneficial to have one user's edits be shown to the other user as soon as possible in order to prevent the users from trying to simultaneously edit the same text. Depending on the locations within a document users are editing, the document update upload rate can be adjusted accordingly. For example, if two users are editing the same sentence of a document, the document update upload rate is adjusted so the updates are transmitted frequently, for example, in one embodiment, every 200 milliseconds. The fast document update upload rate ensures that updates by the different users are transmitted to document collaboration server 110 quickly and changes to the document by each of the users can be transmitted to the respective user devices. For two users editing different paragraphs or different pages of a document, the document update upload rate can be adjusted to be slower than the rate required for two users accessing the same sentence in a document. In one embodiment, a document update upload rate of approximately 2-3 seconds is used when multiple users are editing different paragraphs on the same page. In one embodiment, a document update upload rate of 10 seconds or more is used when multiple users are editing different pages of a document.

Another edit characteristic is the type of document users are editing. Although described above in connection with a word processing document, the techniques described herein can be utilized for different types of documents such as spreadsheets, images, databases, etc. For multiple users collaboratively editing an image, the determination of a document update upload rate can be similar to the determination described in connection with word processing documents. For example, the location within the image where users are editing can be used to adjust the document update upload rate (e.g., the closer the location of edits are to one another, the faster the document update upload rate, and, conversely, the further away the location of edits are to one another, the slower the document update upload rate). In one embodiment, a document update upload rate of 200 milliseconds to 2 seconds is used when multiple users are editing the same image. In one embodiment, when a file contains multiple images and users are editing different images, a document update upload rate of 10 seconds or more is used. For spreadsheets and databases, the document update upload rate can be adjusted based on whether one user's edits can affect information located within the spreadsheet near a location in the spreadsheet where another user is making edits. For example, if a first user is editing values in one location of the spreadsheet that are used to calculate values in a different location of the spreadsheet where a second user is editing, the document update upload rate can be adjusted to be fast (e.g., every several hundred milliseconds) in order for changes necessitated by edits made by the first user to be reflected in data located near the location where the second user is editing. In one embodiment, a document update upload rate of approximately 200 milliseconds is used when multiple users are editing the spreadsheet in locations near one another and when one user's edits can affect the information another user is editing. In one embodiment, a document update upload rate of approximately 2-3 seconds can be used when users are editing spreadsheet data in locations far from one another (e.g., 30-100 cells away from one another).

In one embodiment, a particular document update upload rate can be associated with each user editing a particular document. For example, two users editing a document in locations within the document near one another can each be assigned a fast document update upload rate to ensure that updates are transmitted to the users in a timely fashion. Another user editing the same document but in a location of the document remote from the location of the document in which the two users are editing can be provided with a slower document update upload rate.

Updates can also be triggered by certain events. For example, if a particular user begins to edit a section of a document known to be currently edited by another user, an update can be transmitted to document collaboration server 110 in order to determine a new document update upload rate based on the relative locations of the two users. Changes in other edit characteristics, such as connection speed, connection type, number of users editing a particular document, may also be used as triggers to transmit a message to document collaboration server 110 in order to determine a new document update upload rate for a user.

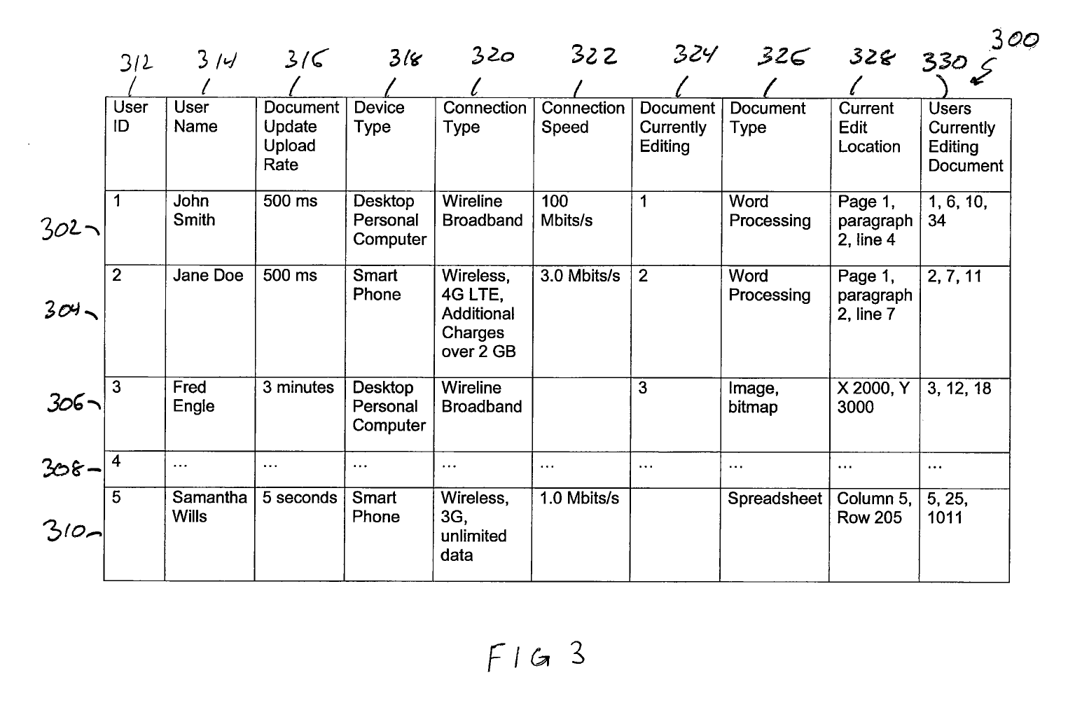

FIG. 3 depicts user table 300 which includes records 302, 304, 306, 308, and 310 each of which contain information related to a particular user. The information contained in table 300 is acquired during initial communication, with a particular user device associated with a user (e.g., when a document is requested from document collaboration server 110). The information contained in table 300 is used by document collaboration server 110 in determining a document update upload rate. User ID 312 is a unique identifier associated with a particular user identified by name in user name 314. Document update upload rate 316 stores the most recently determined document update upload rate associated with the user for a particular document. Device type 318, connection type 320, and connection speed 322 store information related to the device utilized by users and related connection information. Information concerning particular documents is stored in document currently editing 324, document type 326, and users currently editing document 330. Information concerning editing of a document are stored in current edit location 328. Documents stored in database 112 can include original documents, multiple versions of a document, and edit information (user, edits, dates, etc.) related to documents. It should be noted that in embodiments where the document update upload rate is determined by a user device, information similar to the information depicted in table 300 may be stored in the memory of the user device.

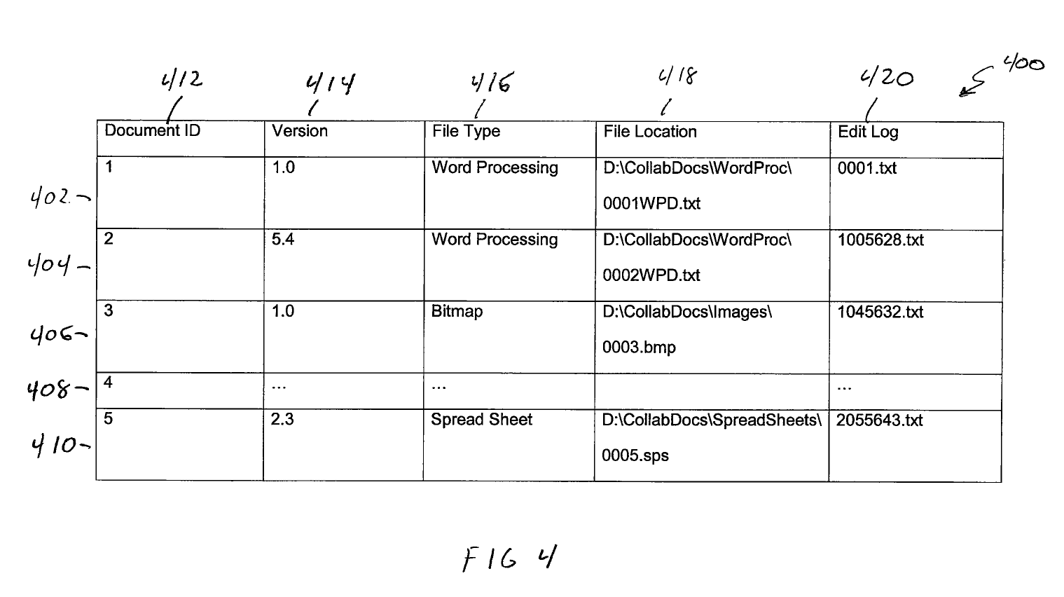

FIG. 4 depicts document table 400 that includes records 402, 404, 406, 408, and 410 each of which contain information related to a particular document. In one embodiment, the information stored in table 400 is acquired by document collaboration server 110 when a document is uploaded. A document can be uploaded by a user prior to collaborative editing of the document. The information stored in table 400 is used by document collaboration server to determine a document update upload rate for a user editing the document. The information stored in table 400 is also used to track changes to a document. A particular document is identified in document ID 412 with the location of the document identified in file location 418. Additional information pertaining to a particular document is stored in version 414 and file type 416. Edit log 420 stores information concerning edits made to a particular document. Edit log 420 can contain a file, such as a text file, detailing edits made to the particular document.

It should be noted that the network round trip time between a user device (e.g., user 1 device 102) and document collaboration server 110 can be considered in determining a minimum value for the document update upload rate. Values for the document update upload rate less then the network round trip time provide negligible benefits since the network round trip time will limit the minimum document update upload rate. A network round trip time can, in one embodiment, be assumed to be 100-200 milliseconds. In another embodiment, the network round trip time can be determined and used to set a lower bound for the document update upload rate.

Systems, apparatus, and methods described herein may be implemented using digital circuitry, or using one or more computers using well-known computer processors, memory units, storage devices, computer software, and other components. Typically, a computer includes a processor for executing instructions and one or more memories for storing instructions and data. A computer may also include, or be coupled to, one or more mass storage devices, such as one or more magnetic disks, internal hard disks and removable disks, magneto-optical disks, optical disks, etc.

Systems, apparatus, and methods described herein may be implemented using computers operating in a client-server relationship. Typically, in such a system, the client computers are located remotely from the server computer and interact via a network. The client-server relationship may be defined and controlled by computer programs running on the respective client and server computers.

Systems, apparatus, and methods described herein may be used within a network-based cloud computing system. In such a network-based cloud computing system, a server or another processor that is connected to a network communicates with one or more client computers via a network. A client computer may communicate with the server via a network browser application residing and operating on the client computer, for example. A client computer may store data on the server and access the data via the network. A client computer may transmit requests for data, or requests for online services, to the server via the network. The server may perform requested services and provide data to the client computer(s). The server may also transmit data adapted to cause a client computer to perform a specified function, e.g., to perform a calculation, to display specified data on a screen, etc. For example, the server may transmit a request adapted to cause a client computer to perform one or more of the method steps described herein, including one or more of the steps of FIGS. 2A and 2B. Certain steps of the methods described herein, including one or more of the steps of FIGS. 2A and 2B, may be performed by a server or by another processor in a network-based cloud-computing system. Certain steps of the methods described herein, including one or more of the steps of FIGS. 2A and 2B, may be performed by a client computer in a network-based cloud computing system. The steps of the methods described herein, including one or more of the steps of FIGS. 2A and 2B, may be performed by a server and/or by a client computer in a network-based cloud computing system, in any combination.

Systems, apparatus, and methods described herein may be implemented using a computer program product tangibly embodied in an information carrier, e.g., in a non-transitory machine-readable storage device, for execution by a programmable processor; and the method steps described herein, including one or more of the steps of FIGS. 2A and 2B, may be implemented using one or more computer programs that are executable by such a processor. A computer program is a set of computer program instructions that can be used, directly or indirectly, in a computer to perform a certain activity or bring about a certain result. A computer program can be written in any form of programming language, including compiled or interpreted languages, and it can be deployed in any form, including as a stand-alone program or as a module, component, subroutine, or other unit suitable for use in a computing environment.

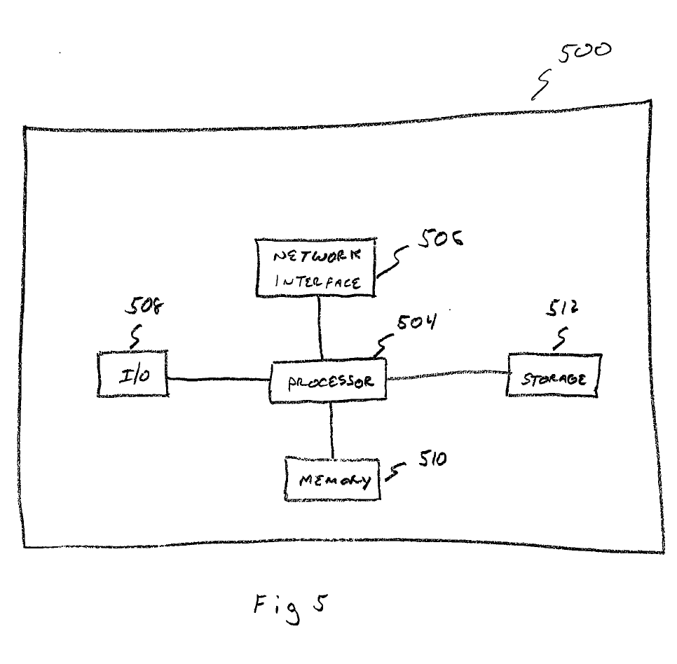

A high-level block diagram of an exemplary computer that may be used to implement systems, apparatus, and methods described herein is depicted in FIG. 5. Computer 500 includes a processor 502 operatively coupled to a data storage device 512 and a memory 510. Processor 502 controls the overall operation of computer 500 by executing computer program instructions that define such operations. The computer program instructions may be stored in data storage device 512, or other computer readable medium, and loaded into memory 510 when execution of the computer program instructions is desired. Thus, the method steps of FIGS. 2A and 2B can be defined by the computer program instructions stored in memory 510 and/or data storage device 512 and controlled by processor 502 executing the computer program instructions. For example, the computer program instructions can be implemented as computer executable code programmed by one skilled in the art to perform an algorithm defined by the method steps of FIGS. 2A and 2B. Accordingly, by executing the computer program instructions, the processor 502 executes an algorithm defined by the method steps of FIGS. 2A and 2B. Computer 500 also includes one or more network interfaces 506 for communicating with other devices via a network. Computer 500 also includes one or more input/output devices 508 that enable user interaction with computer 500 (e.g., display, keyboard, mouse, speakers, buttons, etc.).

Processor 502 may include both general and special purpose microprocessors, and may be the sole processor or one of multiple processors of computer 500. Processor 502 may include one or more central processing units (CPUs), for example. Processor 502, data storage device 512, and/or memory 510 may include, be supplemented by, or incorporated in, one or more application-specific integrated circuits (ASICs) and/or one or more field programmable gate arrays (FPGAs).

Data storage device 512 and memory 510 each include a tangible non-transitory computer readable storage medium. Data storage device 512, and memory 510, may each include high-speed random access memory, such as dynamic random access memory (DRAM), static random access memory (SRAM), double data rate synchronous dynamic random access memory (DDR RAM), or other random access solid state memory devices, and may include non-volatile memory, such as one or more magnetic disk storage devices such as internal hard disks and removable disks, magneto-optical disk storage devices, optical disk storage devices, flash memory devices, semiconductor memory devices, such as erasable programmable read-only memory (EPROM), electrically erasable programmable read-only memory (EEPROM), compact disc read-only memory (CD-ROM), digital versatile disc read-only memory (DVD-ROM) disks, or other non-volatile solid state storage devices.

Input/output devices 508 may include peripherals, such as a printer, scanner, display screen, etc. For example, input/output devices 508 may include a display device such as a cathode ray tube (CRT) or liquid crystal display (LCD) monitor for displaying information to the user, a keyboard, and a pointing device such as a mouse or a trackball by which the user can provide input to computer 800.

Any or all of the systems and apparatus discussed herein, including user devices 102, 104, and 106, document collaboration server 110, and database 112, may be implemented using a computer such as computer 500.

One skilled in the art will recognize that an implementation of an actual computer or computer system may have other structures and may contain other components as well, and that FIG. 5 is a high level representation of some of the components of such a computer for illustrative purposes.

The foregoing Detailed Description is to be understood as being in every respect illustrative and exemplary, but not restrictive, and the scope of the invention disclosed herein is not to be determined from the Detailed Description, but rather from the claims as interpreted according to the full breadth permitted by the patent laws. It is to be understood that the embodiments shown and described herein are only illustrative of the principles of the present invention and that various modifications may be implemented by those skilled in the art without departing from the scope and spirit of the invention. Those skilled in the art could implement various other feature combinations without departing from the scope and spirit of the invention

1. A method for collaborative document editing comprising:
receiving, at a document collaboration server, a request from a first user device for a master document;
determining, at the document collaboration server, a first document update upload rate for the first user device based on a connection type and a connection speed between the first user device and the document collaboration server;
transmitting, to the first user device, a first copy of the master document and the first document update upload rate for the first user device;
receiving, at the document collaboration server from the first user device, edits from a first user editing the first copy of the master document;
determining, at the document collaboration server, a second document update upload rate for the first user device based on edit characteristics including a number of users editing copies of the master document and a current edit location within the first copy of the master document for the first user; and
transmitting, to the first user device, the second document update upload rate for the first user device.

2. The method of claim 1 further comprising:
receiving, at the document collaboration server from a second user device, edits from a second user editing a second copy of the master document; and
determining, at the document collaboration server, a third document update upload rate for the first user device and a first document update upload rate for the second user device based on edit characteristics including the number of users editing copies of the master document, the current edit location within the first copy of the master document for the first user device, and a second current edit location within the second copy of the master document for the second user device.

3. The method of claim 1 wherein the determining the second user document update upload rate for the first user device comprises:
determining a plurality of prospective document update upload rates, each of the plurality of prospective document update upload rates associated with a corresponding one of the edit characteristics; and
selecting a fastest document update upload rate from the plurality of prospective document update upload rates as the second user document update upload rate for the first user device.

4. The method of claim 2 further comprising:
transmitting the third document update upload rate for the first user device to the first user device; and
transmitting the first document update upload rate for the second user device to the second user device.

5. The method of claim 2 wherein information identifying the connection type and connection speed between the first user device and the document collaboration server is transmitted from the first user device to the document collaboration server.

6. The method of claim 1 wherein the number of users editing copies of the master document is determined by the document collaboration server based on a number of user devices requesting copies of the master document.

7. The method of claim 1 further comprising:
determining, at the document collaboration server, the current edit location within the first copy of the master document for the first user device and the second current edit location within the second copy of the master document for the second user device based on edits received from the first user device and the second user device.

8. The method of claim 1 wherein the edit characteristics further include the connection type and the connection speed between the first user device and the document collaboration server.

9. A method for collaborative document editing comprising:
receiving, at a user device, an edit of a document from a particular user;
receiving a document update upload rate from a document collaboration server; and
transmitting the edit to the document collaboration server based on the document update upload rate,
wherein the document update upload rate is based on edit characteristics including a number users collaboratively editing the document and a current edit location within the document for the particular user.

10. The method of claim 9 wherein the edit characteristics further include a connection type between the user device and the document collaboration server.

11. The method of claim 9 wherein the edit characteristics further include a connection speed between the user device and the document collaboration server.

12. The method of claim 9 further comprising:
transmitting to the document collaboration server an indication of a change in the current edit location within the document for the particular user.

13. The method of claim 12 further comprising:
receiving a new document update upload rate based on the change in the current edit location within the document for the particular user.

14. The method of claim 9 further comprising:
transmitting data to the document collaboration server indicating a change in a connection speed between the user device and the document collaboration server.

15. The method of claim 12 further comprising:
receiving a new document update upload rate in response to the transmitting to the document collaboration server an indication of a change in the current edit location, the new document update upload rate based on a determination that changes made in a new current edit location for the user affect information in an edit location for another user.

16. An article of manufacture including a tangible computer-readable medium having instructions stored thereon, that in response to execution by a computing device cause the computing device to perform operations comprising:
receiving, at a document collaboration server, a request from a first user device for a master document;
determining, at the document collaboration server, a first document update upload rate for the first user device based on a connection type and a connection speed between the first user device and the document collaboration server;
transmitting, to the first user device, a first copy of the master document and the first document update upload rate for the first user device;
receiving, at the document collaboration server from the first user device, edits from a first user editing the first copy of the master document;
determining, at the document collaboration server, a second document update upload rate for the first user device based on edit characteristics including a number of users editing copies of the master document and a current edit location within the first copy of the master document for the first user; and
transmitting, to the first user device, the second document update upload rate for the first user device.

17. The article of manufacture of 16 wherein the operations further comprise:
receiving, at the document collaboration server from a second user device, edits from a second user editing a second copy of the master document; and
determining, at the document collaboration server, a third document update upload rate for the first user device and a first document update upload rate for the second user device based on edit characteristics including the number of users editing copies of the master document, the current edit location within the first copy of the master document for the first user device, and a second current edit location within the second copy of the master document for the second user device.

18. The article of manufacture of 16 wherein the determining the second user document update upload rate for the first user device comprises:
determining a plurality of prospective document update upload rates, each of the plurality of prospective document update upload rates associated with a corresponding one of the edit characteristics; and
selecting a fastest document update upload rate from the plurality of prospective document update upload rates as the second user document update upload rate for the first user device.

19. The article of manufacture of claim 17 wherein the operations further comprise:
transmitting the third document update upload rate for the first user device to the first user device; and
transmitting the first document update upload rate for the second user device to the second user device.

20. The article of manufacture of claim 17 wherein information identifying the connection type and connection speed between the first user device and the document collaboration server is transmitted from the first user device to the document collaboration server.

21. The article of manufacture of claim 16 wherein the number of users editing copies of the master document is determined by the document collaboration server based on a number of user devices requesting copies of the master document.

22. The article of manufacture of claim 16 wherein the operations further comprise:
determining, at the document collaboration server, the current edit location within the first copy of the master document for the first user device and the second current edit location within the second copy of the master document for the second user device based on edits received from the first user device and the second user device.

23. The article of manufacture of claim 16 wherein the edit characteristics further include the connection type and the connection speed between the first user device and the document collaboration server.

24. An article of manufacture including a tangible computer-readable medium having instructions stored thereon, that in response to execution by a computing device cause the computing device to perform operations comprising:
receiving at a user device an edit of a document from a particular user;
receiving a document update upload rate from a document collaboration server; and
transmitting the edit to the document collaboration server based on the document update upload rate,
wherein the document update upload rate is based on edit characteristics including a number users collaboratively editing the document and a current edit location within the document for the particular user.

25. The article of manufacture of 24 wherein the edit characteristics further include a connection type between the user device and the document collaboration server.

26. The article of manufacture of 24 wherein the edit characteristics further include a connection speed between the user device and the document collaboration server.

27. The article of manufacture of claim 24 wherein the operations further comprise transmitting to the document collaboration server an indication of a change in the current edit location within the document for the particular user.

28. The article of manufacture of claim 27 wherein the operations further comprise:
receiving a new document update upload rate based on the change in the current edit location within the document for the particular user.

29. The article of manufacture of claim 24 wherein the operations further comprise:
transmitting data to the document collaboration server indicating a change in a connection speed between the user device and the document collaboration server.

30. The method of claim 27 further comprising:
receiving a new document update upload rate in response to the transmitting to the document collaboration server an indication of a change in the current edit location, the new document update upload rate based on a determination that changes made in a new current edit location for the user affect information in an edit location for another user.
